(19) United States
(12) Patent Application Publication
(10) Pub. No.: US 2011/0111624 A1
(43) Pub. Date: May 12, 2011

(54) Broadband Interface Connection System

(76) Inventor: David Ball, Hudson, WI (US)

(21) Appl. No.: 12/862,454

(22) Filed: Aug. 24, 2010

Related U.S. Application Data
(60) Provisional application No. 61/280,977, filed on Nov. 12, 2009.

(51) Int. Cl. H01R 9/05

(52) U.S. Cl. 439/578

(57) ABSTRACT

A broadband interface connection system includes a main nut assembly including a main nut, a main cylindrical body having a projection on its outer surface, a main nut gasket, a spring body, a slip ring, and a threaded top cylindrical body; a housing receptacle assembly including a housing body having a gasket seat and a bore configured to accept the main cylindrical body, a ferrule in the bore, a tapered cable center conductor alignment section, and a housing female center pin coupled with the section; and a jacket outer seal nut assembly including a jacket outer seal nut, and a jacket outer seal gasket at a bottom of the jacket outer seal nut. In addition to the main nut assembly's elements, a terminator assembly includes an insulator, a resistor, and a center pin, and a connector adaptor assembly includes an insulator, a feed through center pin, and a test port.

### RELATED APPLICATIONS

This application claims priority to U.S. Provisional Patent Application Ser. No. 61/280,977 filed Nov. 12, 2009, which is hereby incorporated by reference in its entirety for all purposes.

### BACKGROUND OF THE INVENTION

All drop systems starting from a distribution system including a satellite dish, a CATV distribution system, and a traditional telephone system have the same purpose of faithfully transmitting RF energy from the distribution system to a television, a cable modem, or other devices to which the RF energy is directed.

Within a drop system, there are points in the cable lines where either passive or active devices are inserted for a variety of purposes. Ground blocks may be inserted to provide a grounding point designed to provide electrical safety from voltage surges. Splitters and diplexers may be inserted to split a RF signal from a single cable to a number of cables to distribute the RF signal to a multitude of devices within a dwelling, or filter certain portions of RF signal's spectra. Amplifiers may be inserted to boost signal levels. Splice fittings may be inserted to repair or replace a damaged cable.

At the end of the drop system, the cable may be terminated into a variety of devices including set top boxes, cable modems, etc. designed to produce a final product, namely voice, video, or data.

Where each of the devices as described above is inserted into the cable lines, there are connections to be made between the cable and the inserted devices. In the conventional method of making these connections, an inserted device having threaded female ports, which accept F male connectors with a protruding center conductor is used. These connections serve the following purposes. The first purpose is to provide an electrically compatible transition from the cable to the device being inserted. The cable sizes vary from RG-59 to RG-11 sized braided cables. The second is to protect an electrical connection from the environment by sealing the connection from moisture, dust, and other elements, which might degrade an electrical path. The third is to keep RF energy confined in the transmission system and to keep external signals from entering the transmission system. The fourth is to maintain a mechanically strong connection. The mechanically strong connection will maintain an electrical connection despite external mechanical forces. The fifth is to allow the inserted devices to be connected and disconnected repeatedly for the purposes of system maintenance, upgrades, and alterations. These connections between the cable and the inserted devices are a constant source of maintenance and reliability issues for the service providers. For example, metallic incompatibility may occur in the form of galvanic reactions, and accelerated corrosion. The connections between the cable and the inserted devices may be susceptible to improper torque of the nut by the craftsperson allowing for degradation of the outer conductor performance, and the ingress/egress of electrical signals. Poor performance may occur over time due to the fact that there are generally three electrical connections made with the standard feed through connector, and up to four connections made with a captivated pin type connector. Each connector must be installed with its corresponding seal ring. Using other manufacturer's seal rings will reduce its effectiveness in sealing the connections. This may create compatibility issues, and the need to maintain stock organization. Moreover, compression tools are not always compatible between connector manufacturers and specific tools for each connector type used are required.

To increase the reliability of the drop system, a connection, which eliminates these issues is required. These issues may be eliminated by, for example, encapsulating the electrical connections, reducing the number of electrical connections made, simplifying and standardizing the installation process, and eliminating dissimilar metal issues.

### SUMMARY OF THE INVENTION

Embodiments are directed to a universal broadband interface connection system, which increases reliability of a drop system.

It is therefore a feature of an embodiment to provide a cable connection system including: a main nut assembly including a main nut, a main cylindrical body having a projection on an outer surface thereof and having a first end and a second end, the first end being coupled with a bottom of the main nut, a main nut gasket engaged with the main cylindrical body, a spring body coupled with the second end of the main cylindrical body, a first slip ring configured to be engage with the spring body, and a top cylindrical body having a thread on an outer surface thereof, the top cylindrical body being coupled with a top of the main nut; a housing receptacle assembly including, a housing body having a gasket seat and a bore configured to accept the main cylindrical body, a ferrule in the bore, the ferrule having a first opening below a bottom of the gasket seat, a tapered cable center conductor alignment section having a second opening and a third opening smaller than the second opening, the second opening being coupled with the first opening, and a housing female center pin coupled with the third opening; and a jacket outer seal nut assembly including a jacket outer seal nut, and a jacket outer seal gasket at a bottom of the jacket outer seal nut, wherein a hole of the main nut is coupled with a hole of the main cylindrical body and a hole of the top cylindrical body.

The housing receptacle assembly may further include an EMI gasket engaged with the outside of the ferrule and the inside of the bore. The main nut may have wrench flats on sides thereof. Alternatively, the main nut may have a knurled outer surface on sides thereof. The projection may be a thread and the bore may have a thread on an inner surface thereof. Alternatively, the projection may be a twist lock male and the bore may have a slot configured to accept the twist lock male on an inner surface thereof. Alternatively, the projection may be a bayonet male, and the bore may have a slot configured to accept the bayonet male on an inner surface thereof. The spring body may include a spring tine. Alternatively, the spring body may include a braid compression barrel, and the first slip ring may be coupled with a first end of the braid compression barrel and a second slip ring is coupled with a second end of the braid compression barrel. The braid compression barrel may be between a snap tab and a main nut spring. The main nut spring may be a spring coil or a spring washer. An outer surface of the ferrule may have a second projection configured to hold the cable. A size of the ferrule may be configured to accept a dielectric portion of the cable. The hole of the main nut may have a portion tapered toward one opening of the main nut from the other opening of the main nut, and the other opening of the main nut may be adjacent to the top cylindrical. The jacket outer seal gasket may be tapered toward a side opposite to a side coupled with the bottom of the jacket outer seal nut. The ferrule may be configured to accept a coaxial cable when a dielectric of the coaxial cable slides into the ferrule, and a braid and a jacket of the coaxial cable slide to the outside of the ferrule.

It is therefore another feature of an embodiment to provide a terminator assembly for the housing receptacle assembly including: a main nut; a main cylindrical body having a projection on an outer surface thereof and having a first end and a second end, the first end being coupled with a bottom of the main nut; a main nut gasket engaged with the main cylindrical body; a spring body coupled with the second end of the main cylindrical body; a first slip ring engaged with the spring body; an insulator coupled with the main cylindrical body; a resistor electrically coupled with an outer surface of the main nut; and a center pin coupled with the insulator and the resistor.

The terminator assembly may further include an outer sleeve electrically coupling the resistor with the outer surface of the main nut. The main nut may have wrench flats on sides thereof. Alternatively, the main nut may have a knurled outer surface on sides thereof. The projection may be a thread. Alternatively, the projection may be a twist lock male. Alternatively, the projection may be a bayonet male. The spring body may include a spring tine. Alternatively, the spring body may include a braid compression barrel, and the first slip ring may be coupled with a first end of the braid compression barrel and a second slip ring is coupled with a second end of the braid compression barrel. The braid compression barrel may be between a snap tab and a main nut spring. The main nut spring may be a spring coil or a spring washer. The resistor may be 75 ohm. The center pin may be mechanically captivated by the insulator.

It is therefore another feature of an embodiment to provide the connector adaptor assembly including: a main nut; a main cylindrical body having a projection on an outer surface thereof and having a first end and a second end, the first end being coupled with a bottom of the main nut; a main nut gasket engaged with the main cylindrical body; a spring body coupled with the second end of the main cylindrical body; a first slip ring engaged with the spring body; an insulator coupled with the second end of the main cylindrical body; a feed through center pin coupled with the insulator; and a test port coupled with the main nut.

The connector adaptor assembly may further include an outer sleeve electrically coupled with a port inserted in the main nut. The main nut may have wrench flats on sides thereof. Alternatively, the main nut may have a knurled outer surface on sides thereof. The projection may be a thread. Alternatively, the projection may be a twist lock male. Alternatively, the projection may be a bayonet male. The spring body may include a spring tine. Alternatively, the spring body may include a braid compression barrel, and the first slip ring may be coupled with a first end of the braid compression barrel and a second slip ring is coupled with a second end of the braid compression barrel. The braid compression barrel may be between a snap tab and a main nut spring. The main nut spring may be a spring coil or a spring washer. The feed through center pin may be mechanically captivated by the insulator. The test port may be a 75 ohm F female port, a 75 ohm BNC female port, a 75 ohm N female port, or a 75 ohm MCX female port.

### BRIEF DESCRIPTION OF THE DRAWINGS

Embodiments of the invention may be best understood by referring to the following description and accompanying drawings, which illustrate such embodiments. In the drawings:

FIG. 1 illustrates a multi-view of a broadband interface connection system in accordance with one embodiment.

FIG. 2 illustrates a multi-view of a broadband interface connection system in accordance with another embodiment.

FIG. 3 illustrates a multi-view of a broadband interface connection system in accordance with another embodiment.

FIG. 4 illustrates a side view of a main nut assembly in accordance with another embodiment.

FIG. 5 illustrates main nut springs in accordance with several embodiments.

FIG. 6 illustrates a cross-sectional view of a housing receptacle assembly and a side view of a terminator assembly in accordance with one embodiment.

FIG. 7 illustrates a cutaway of an outer sleeve in the terminator assembly illustrated in FIG. 6.

FIG. 8 illustrates a cross-sectional view of a housing receptacle assembly and a side view of a connector adapter assembly in accordance with one embodiment.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the invention. The following detailed description is, therefore, not to be taken in a limiting sense, and the scope of the invention is defined by the appended claims and their equivalents.

Before the invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the invention. All such modifications are intended to be within the scope of the claims made herein.

Methods recited herein may be carried out in any order of the recited events, which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the terms “include,” “for example,” “such as,” and the like are used illustratively and are not intended to limit the invention.

As used herein, the terms “top,” “bottom,” and “below” in this description are merely used to identify the various elements as they are oriented in the FIGS, with “top,” “bottom,” and “below” being relative apparatus. These terms are not meant to limit the element which they describe, as the various elements may be oriented differently in various applications.

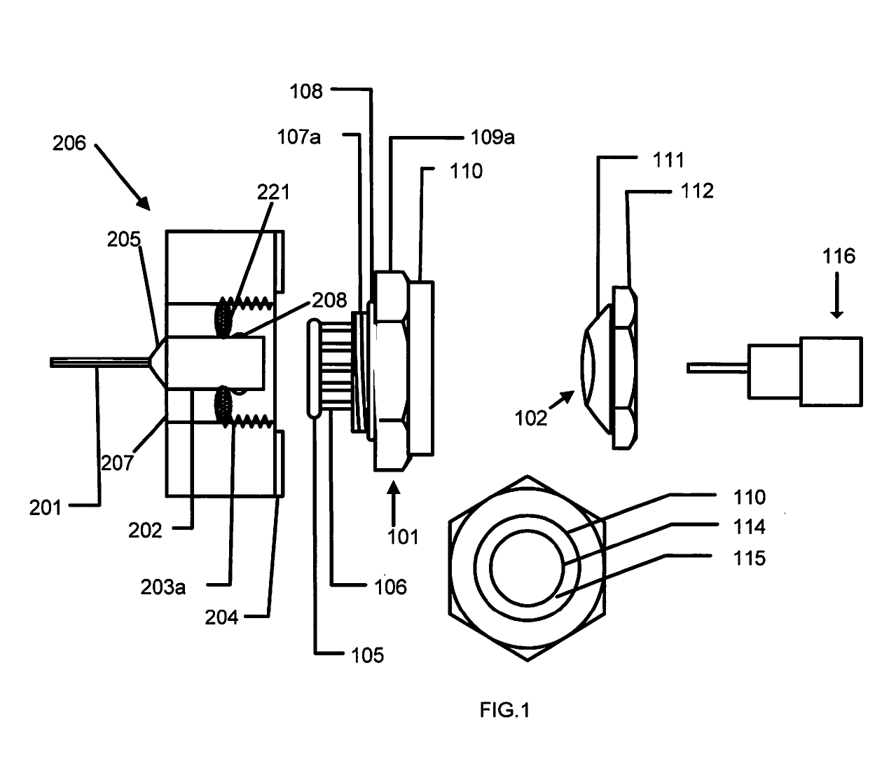

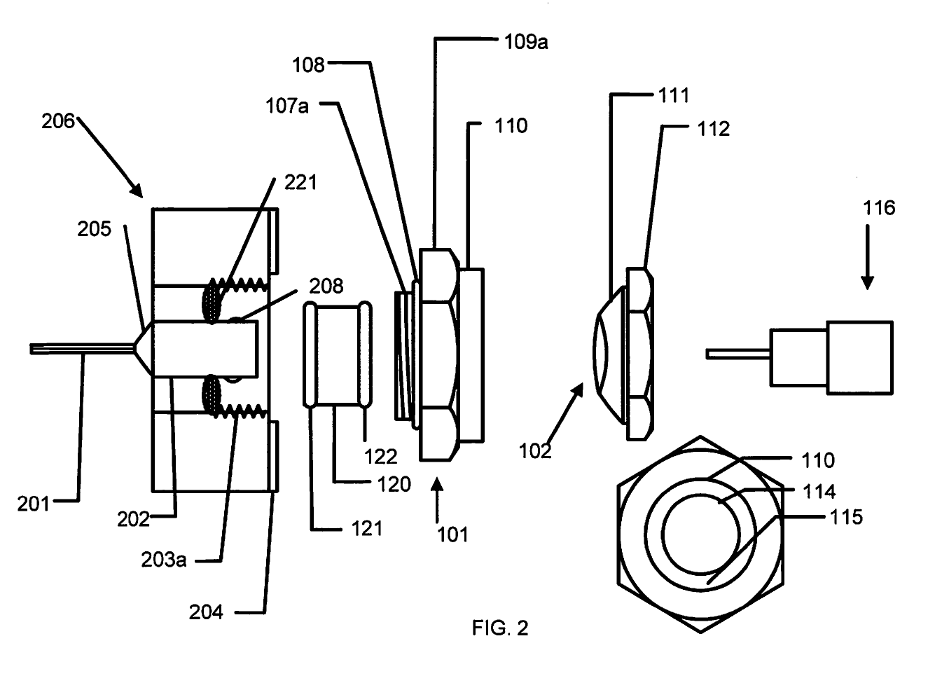

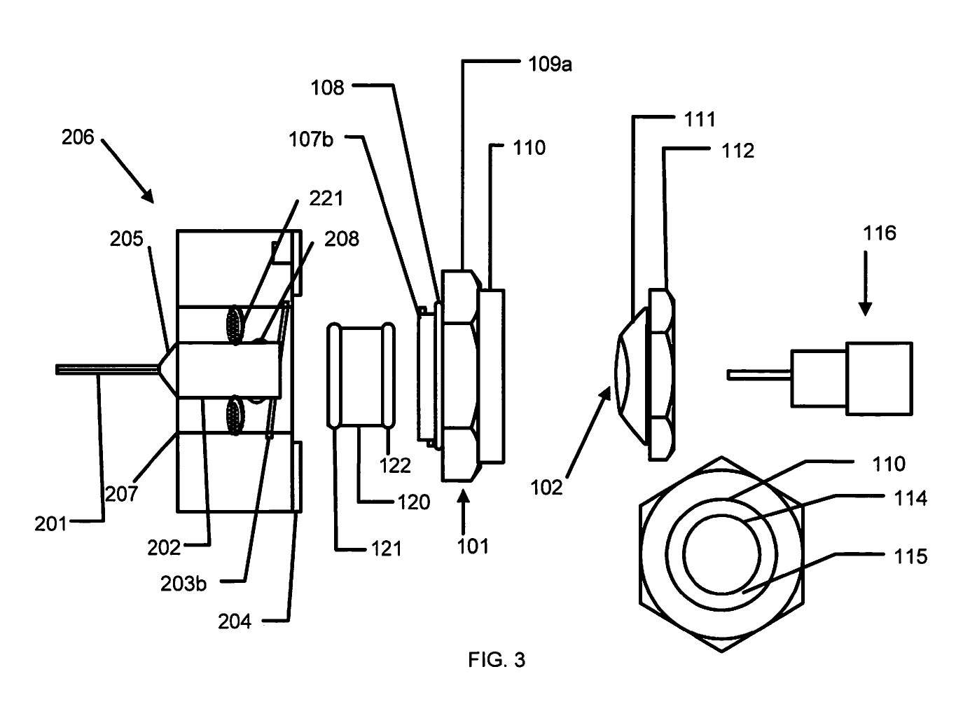

FIG. 1 illustrates multi-view of a broadband interface connection system of one embodiment. FIG. 2 illustrates a multi-view of a broadband interface connection system of another embodiment. FIG. 3 illustrates a multi-view of a broadband interface connection system of another embodiment. The respective multi-view illustrated in FIGS. 1-3 includes a side view of a main nut assembly 101, a cross-sectional view of a housing receptacle assembly 206, and a side view of a jacket outer seal nut assembly 102. The housing receptacle assembly 206 as illustrated in FIGS. 1-3 may represent all active and passive product housings.

The broadband interface connection system includes the main nut assembly 101, the housing receptacle assembly 206, and the jacket outer seal nut assembly 102. The main nut assembly 101 and the jacket outer seal nut assembly 102 may be removable from the housing receptacle assembly 206. Referring to FIG. 1, the main nut assembly 101 includes a main nut 109a, a main cylindrical body 107a having a projection on an outer surface thereof, a main nut gasket 108 engaged with the main cylindrical body 107a, a spring body 106, a first slip ring 105 configured to be engaged with the spring body 106, and a top cylindrical body 110 having a thread on an outer surface thereof. The top cylindrical body 110 is coupled with a top of the main nut 109a. The main cylindrical body 107a has a first end and a second end. The first end of the main cylindrical body 107a is coupled with a bottom of the main nut 109a. The spring body 106 is coupled with the second end of the main cylindrical body 107a. The main nut 109a may have wrench flats on sides thereof, as illustrated in FIG. 1.

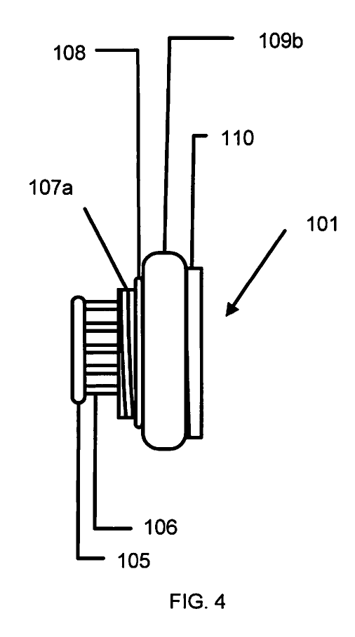

Alternatively, the main nut assembly 101 may include a main nut 109b having a knurled outer surface configured to be tighten with fingers on sides thereof, as illustrated in FIG. 4.

Referring to FIG. 1, the housing receptacle assembly 206 includes a housing body 207 having a gasket seat 204 and a bore 203a configured to accept the main cylindrical body 107a, a ferrule 202 in the bore 203a, a tapered cable center conductor alignment section 205 having a second opening and a third opening smaller than the second opening, and a housing female center pin 201 coupled with the third opening. The ferrule 202 has a first opening below a bottom of the housing body 207. The second opening of the tapered cable center conductor alignment section 205 is coupled with the first opening of the ferrule 202.

The projection of the main cylindrical body 107a may be a thread, and the bore 203a may have a thread on an inner surface thereof, as illustrated in FIGS. 1 and 2. As alternatives of the main cylindrical body 107a and the bore 203a, the main nut assembly 101 may include the main cylindrical body 107b having a projection, which is a twist lock male or bayonet male, and the bore 203b having a slot configured to accept the twist lock male or the bayonet male on an inner surface thereof, as illustrated in FIG. 3.

The jacket outer seal nut assembly 102 includes a jacket outer seal nut 112 and a jacket outer seal gasket 111 at a bottom of the jacket outer seal nut 112. A hole of the main cylindrical body 107a is coupled with a hole of the main nut 109a. The hole of the main nut 109a is coupled with a hole of the top cylindrical body 110. The jacket outer seal gasket 111 may be tapered toward a side opposite to a side coupled with the bottom of the jacket outer seal nut 112.

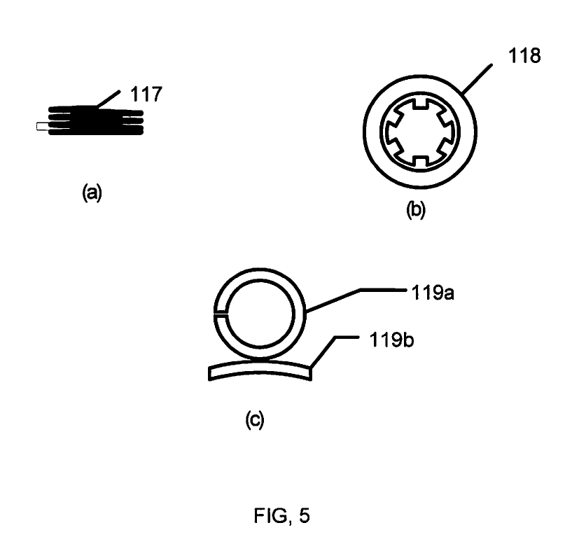

The spring body 106 may include a spring tine (not shown) as illustrated in FIG. 1. Alternatively, the spring body 106 may include a braid compression barrel 120, as illustrated in FIGS. 2 and 3. The first slip ring 121 may be coupled with a first end of the braid compression barrel 120 and a second slip ring 122 may be coupled with a second end of the braid compression barrel 120. The compression barrel 120 may snap into the main nut assembly 101 and float between the snap tabs (not shown) and a main nut spring. The main nut spring may include a spring coil 117 as illustrated in FIG. 5(a). Alternatively, the main nut spring may include a spring washer 118 or 119a, as illustrated in FIGS. 5(b) and (c). Such a main nut spring may provide constant pressure on the cable braid wires.

The gasket seat 204 may be configured to rest any mating nut gasket at the face of the housing receptacle assembly 206. The housing body 207 may have a threaded bore 203a as illustrated in FIGS. 1-2. The bore 203a may be configured to accept all mating threads. Alternatively, the housing body 207 may have a twist lock or bayonet type bore 203b as illustrated in FIG. 3. The bore 203b may be configured to accept all mating twist lock males or bayonet males. The depth of the bore 203a or 203b may be set by the final insertion length of all mating devices. At the center of the bore 203a or 203b lies a ferrule 202. The ferrule 202 may be configured to accept a coaxial cable so that a dielectric of a coaxial cable slides into the ferrule 202, and a braid and a jacket of the coaxial cable slide to the outside of the ferrule 202. The ferrule 202 may be sized to accept a dielectric of a mating cable. An EMI gasket 221 may be engaged with the outside of the ferrule 202 and the inside of the bore 203a or 203b. The EMI gasket 221 may lie at the base of the bore 203a or 203b when the main cylindrical body 107a or 107b is inserted in the bore 203a or 203b. At the base of the ferrule 202 is a tapered cable center conductor alignment section 205. The tapered cable center conductor alignment section 205 may be configured to align a cable center conductor with a housing female center pin 201. The dimensions between an inner diameter of the ferrule 202 and the housing female center pin 201 may be such as to maintain a 75 ohm impedance value for proper RF signal transmission.

The main nut assembly 101 and the jacket outer seal nut 112 may have in their center an opening configured to allow an un-prepped mating cable to pass through. The hole of the main nut 109a or 109b may have a portion 115 tapered toward a first opening 114 of the main nut 109a or 109b from a second opening of the main nut 109a or 109b. The second opening of the main nut 109a or 109b is adjacent to the top cylindrical body 110. The tapered jacket outer seal gasket may rest on the tapered portion 115.

Beyond the housing receptacle assembly 206, the components may be determined by what type of device this interface is to be attached to.

Referring to FIGS. 1-3, the jacket outer seal nut 112 is slid on to an un-prepped cable end with the jacket outer seal gasket 111 facing the main nut assembly 101, which is a mating device of the jacket outer seal nut assembly 102. The main nut assembly 101 is slid on to the un-prepped cable end with the first slip ring 105 facing the housing receptacle assembly 206, which is a mating device of the main nut assembly 101. The cable end is then prepped using tools such as standard industry tools creating what is commonly referred to as a (¼/¼) prep. This creates ¼ inch of exposed center conductor and ¼ inch of unjacketed cable section exposing an outer conductor braid. An exemplary prepped cable 116 is illustrated in FIGS. 1-3.

The exposed outer conductor braid of the cable 116 is next flared so that access of the braid is approximately perpendicular to the access of the cable 116. The prepped cable end is then inserted into the housing receptacle assembly 206 such that the dielectric of the cable 116 fits snuggly inside the ferrule 202, and then an outer circumference of the ferrule 202 slides between the dielectric of the cable 116 and the braid of the cable 116. The cable 116 continues to be slid into the housing receptacle assembly 206 until the base of the braid and an end of the cable's jacket bottom out at the bottom of the bore 203a or 203b. At this point, the dielectric of the cable 116 is at the bottom of the ferrule 202, and the cable center conductor is fully inserted into the housing female center pin 201. An outer surface of the ferrule 202 may have a projection 208 configured to hold the cable 116, as illustrated in FIGS. 1-3.

At this point, the main nut assembly 101 is slid down with the cable 116 until the main cylindrical body 107a or 107b engages the projection of the bore 203a or 203b. The main nut assembly 101 is inserted or threaded until the main nut 109a fully seats on the housing receptacle assembly 206. At this point, the main nut gasket 108 is fully compressed inside the gasket seat 204 creating a weather tight seal between the main nut assembly 101 and the housing receptacle assembly 206. Furthermore, at this point, the first slip ring 105 is fully engaged and compresses the braid, which rests at the base of the bore 203a or 203b, and the spring body 106 or 120 is in their maximum compression state.

The first slip ring 105 is snapped on to the end of the spring body 106 or 120 in such a way that the first slip ring 105 is free to move axially around the spring body 106 or 120. This allows the first slip ring 105 to stay in place while the main nut assembly 101 is being inserted or threaded into place. This action keeps the braid of the cable 116 from being twisted and damaged during the engagement of the main nut assembly 101, but allows enough compression of the braid to maintain both a secure mechanical connection and a low loss electrical connection. Accordingly, a sufficient EMI seal may be created.

The use of the spring body 106 or 120 allows for uneven distribution of the compression of the first slip ring 105 to the cable braid even if the cable braid is not flared and distributed perfectly evenly. The first slip ring 105 being a complete circle may give full 360° compression of the cable braid. Furthermore, additional EMI protection may be gained when the main nut 109a or 109b firmly engage an outer body of an inserted device.

The next step is to slide the jacket outer seal nut 112 until the jacket outer seal nut 112 engages the top cylindrical body 110. The jacket outer seal gasket 111 embedded on the jacket outer seal nut 112 may engage the main nut gasket seat 115. The main nut gasket seat 115 may be tapered. As the jacket outer seal nut 112 continues to thread into the top cylindrical body 110, the jacket outer seal gasket 111 is forced to tighten around the inserted cable outer jacket. This may create a weatherproof seal between the jacket and the interface system. This then completes the termination of the cable into the housing receptacle assembly 206.

To disengage the cable 116, the jacket outer seal nut 112 is loosened until the jacket outer seal nut 112 is fully disengaged from the top cylindrical body 110. The jacket outer seal nut 112 is then slid back on the cable 116. Next, the main nut assembly 101 is loosened until the main nut assembly 101 is fully disengaged from the bore 203a or 203b of the housing receptacle assembly 206. Then, the cable 116 can be pulled out from the housing receptacle assembly 206 and may be re-engaged using the above-described steps multiple times.

When a RF drop port is unused and no cable is terminated into the port, the port should be terminated with a termination element for several reasons. Firstly, open ports reflect energy back into the system causing poor performance. Secondly, a port, which is not properly terminated will radiate energy, and allow RF energy into the system. Improper termination of the port may cause performance issues. RF energy radiated from the system has to be kept to an absolute minimum to comply with the FCC regulations. Thirdly, the unused port should be protected from other elements.

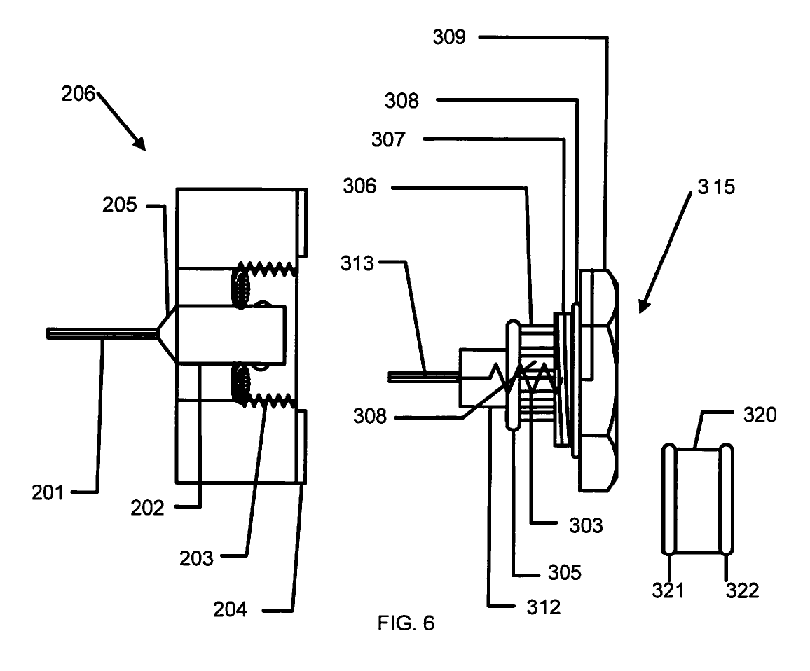

FIG. 6 illustrates a cross-sectional view of an exemplary housing receptacle assembly 206 and a side view of a terminator assembly 315 in accordance with one embodiment. The housing receptacle assembly 206 has been fully described referring to FIGS. 1-3.

Referring to FIG. 6, the terminator assembly 315 includes a main nut 309, a main cylindrical body 307 having a projection on an outer surface thereof, a main nut gasket 308 engaged with the main cylindrical body 307, a spring body 306, a first slip ring 305 engaged with the spring body 306, an insulator 312 coupled with the main cylindrical body 307, a resistor 303 electrically coupled with an outer surface of the main nut 309, and a center pin 313 coupled with the insulator 312 and the resistor 303. The main cylindrical body 307 has a first end, and a second end. The first end is coupled with a bottom of the main nut 309. The spring body 306 is coupled with the second end of the main cylindrical body 307.

The main nut 309 may have wrench flats on sides thereof as illustrated in FIG. 6. Alternatively, the main nut 309 has a knurled outer surface on sides thereof as well as the main nut 109b as illustrated in FIG. 4. The projection of the main cylindrical body 307 may be a thread as illustrated in FIG. 6. Alternatively, the projection of the main cylindrical body 307 may be a twist lock male or a bayonet male as well as the projection of the main cylindrical body 107b as illustrated in FIG. 3. The spring body 306 may include a spring tine as illustrated in FIG. 6. Alternatively, the spring body 306 may include a braid compression barrel 320. The first slip ring 321 is coupled with a first end of the braid compression barrel 320 and a second slip ring 322 is coupled with a second end of the braid compression barrel 320. The braid compression barrel 320 may be between a snap tab and a main nut spring. The main nut spring may be a spring coil or a spring washer as illustrated in FIG. 5. The resistor 303 may be 75 ohm. The center pin 313 may be mechanically captivated by the insulator 312.

The terminator assembly 315 may further include an outer sleeve configured to electrically couple the resistor 303 with the outer surface of the main nut 309.

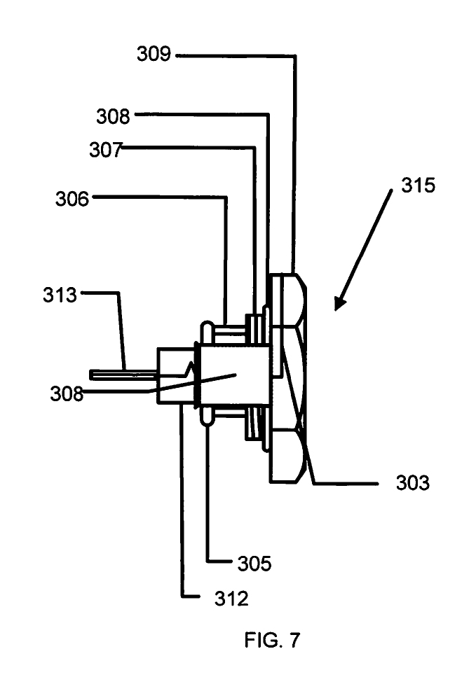

FIG. 7 illustrates a cutaway of the outer sleeve in the terminal assembly 315. The 75 ohm resistor 303 may create proper termination. The outer sleeve may continue the 75 ohm path to the body of the terminator assembly 315. The main nut 309 may not have a through hole. The insulator 312 may simulate the front end of the cable and maintain the 75 ohm RF path.

The center pin 313 may be mechanically captivated by the insulator 312 and tied to the resistor 303, which in turn is tied to the outer body of the terminator assembly 315. As the terminator assembly 315 is inserted or threaded into the bore 203a or 203b, the captivated center pin 313 is inserted into the housing female center pin 201. The insulator 312 slides into the ferrule 202 until the first slip ring 305 bottoms out at the bottom of the bore 203a or 203b. At this point, the outer sleeve continues the outer circumference of the ferrule 202 to the outer body of the terminator assembly 315. Finally, at this point, the main nut gasket 308 is fully compressed inside the gasket seat 204. The port is now properly terminated and protected from other elements.

When servicing a drop system, the drop system often needs to be connected to an industry standard meter. In these cases, the drop system needs to be connected to a 75 ohm F connector. Also, during performance measurements of the inserted devices under laboratory conditions, the above-mentioned connections are required. Thus, an adapter to make connections between the broadband interface connection system and a standard 75 ohm F connector is required.

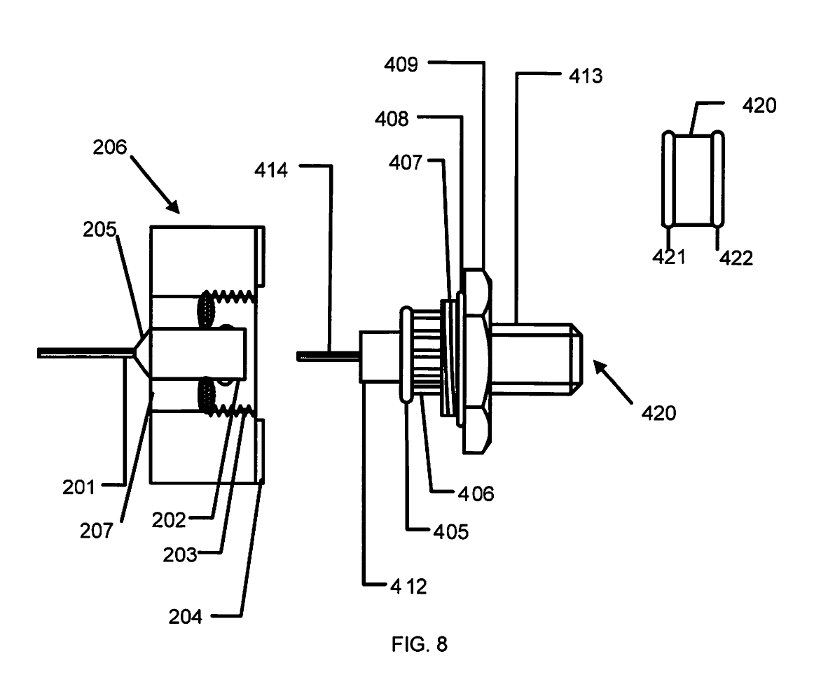

FIG. 8 illustrates a cross-sectional view of an exemplary housing receptacle assembly 206 and a side view of a connector adapter assembly 420 in accordance with one embodiment. The housing receptacle assembly 206 has already been fully described referring to FIGS. 1-3.

Referring to FIG. 8, the connector adapter assembly 420 includes a main nut 409, a main cylindrical body 407 having a projection on an outer surface thereof, a main nut gasket 408 engaged with the main cylindrical body 407, a spring body 406, a first slip ring 405 engaged with the spring body 406, an insulator 412, a feed through center pin 414 coupled with the insulator 412, and a test port 413 coupled with the main nut 409. The main cylindrical body 407 has a first end and a second end. The first end of the main cylindrical body 407 is coupled with a bottom of the main nut 409. The spring body 406 is coupled with the second end of the main cylindrical body 407. The insulator 412 is coupled with the second end of the main cylindrical body 407. The connector adapter assembly 420 may allow a standard F connector attachment used for electrical performance measurements.

The connector adaptor assembly 420 may further include an outer sleeve configured to electrically couple with a test port 413 inserted in the main nut 409 as well as the terminator assembly 315 as illustrated in FIG. 7. The main nut 409 may have wrench flats on sides thereof as illustrated in FIG. 8. Alternatively, the main nut 409 has a knurled outer surface on sides thereof as well as the main nut 109b as illustrated in FIG. 4. The projection of the main cylindrical body 407 may be a thread as illustrated in FIG. 8. Alternatively, the projection of the main cylindrical body 407 may be a twist lock male or a bayonet male as well as the projection of the main cylindrical body 107b as illustrated in FIG. 3. The spring body 406 may include a spring tine as illustrated in FIG. 8. Alternatively, the spring body 406 may include a braid compression barrel 420. The first slip ring 421 may be coupled with a first end of the braid compression barrel 320 and a second slip ring 422 may be coupled with a second end of the braid compression barrel 320. The braid compression barrel 320 may be between a snap tab and a main nut spring. The main nut spring may be a spring coil or a spring washer as illustrated in FIG. 5.

The insulator 412 may simulate the front end of the cable and maintain the 75 ohm RF path. The outer sleeve may continue the test port 413. The main nut 409 may not have a through hole. The test port 413 may be SCTE compliant F port, a 75 ohm BNC, a 75 ohm N, a 75 ohm MCX or any other industry standard interface. As the connector adaptor assembly 420 is inserted or threaded into the bore 203a or 203b, the feed through center pin 414 is inserted into the housing female center pin 201. The insulator 412 slides into the ferrule 202 until the first slip ring 405 bottoms out at the bottom of the bore 203a. At this point, the outer sleeve continues the outer diameter of the ferrule 202 to the test port 413. Finally, at this point the main nut gasket 408 is fully compressed inside the gasket seat 204. The test port 413 has now been adapted into a 75 ohm F female connector and can be connected to with any standard 75 ohm F male connector.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A cable connection system comprising:
a main nut assembly comprising
a main nut,
a main cylindrical body having a projection on an outer surface thereof and having a first end and a second end, the first end being coupled with a bottom of the main nut,
a main nut gasket engaged with the main cylindrical body,
a spring body coupled with the second end of the main cylindrical body,
a first slip ring configured to be engage with the spring body, and
a top cylindrical body having a thread on an outer surface thereof, the top cylindrical body being coupled with a top of the main nut;
a housing receptacle assembly comprising
a housing body having a gasket seat and a bore configured to accept the main cylindrical body,
a ferrule in the bore, the ferrule having a first opening below a bottom of the gasket seat,
a tapered cable center conductor alignment section having a second opening and a third opening smaller than the second opening, the second opening being coupled with the first opening, and
a housing female center pin coupled with the third opening; and
a jacket outer seal nut assembly comprising
a jacket outer seal nut, and
a jacket outer seal gasket coupled with a bottom of the jacket outer seal nut, wherein a hole of the main nut is coupled with a hole of the main cylindrical body and a hole of the top cylindrical body.

2. The cable connection system of claim 1, wherein the housing receptacle assembly further comprises an EMI gasket engaged with the outside of the ferrule and the inside of the bore.

3. The cable connection system of claim 1, wherein the main nut has wrench flats or a knurled outer surface on sides thereof.

4. The cable connection system of claim 1, wherein the projection is a thread and the bore has a thread on an inner surface thereof.

5. The cable connection system of claim 1, wherein the projection is a twist lock male or a bayonet male, and the bore has a slot configured to accept the twist lock male or the bayonet male on an inner surface thereof.

6. The cable connection system of claim 1, wherein the spring body comprises a spring tine or a braid compression barrel.

7. The cable connection system of claim 1, wherein the hole of the main nut has a portion tapered toward one opening of the main nut from the other opening of the main nut, and the other opening of the main nut is adjacent to the top cylindrical.

8. The cable connection system of claim 1, wherein the jacket outer seal gasket is tapered toward a side opposite to a side coupled with the bottom of the jacket outer seal nut.

9. A terminator assembly for a housing receptacle assembly comprising a housing body having a gasket seat and a bore, a ferrule in the bore, the ferrule having a first opening at a bottom of the gasket seat, a tapered cable center conductor alignment section having a second opening and a third opening smaller than the second opening, the second opening being coupled with the first opening, and a housing female center pin coupled with the third opening, the terminator assembly comprising:
a main nut;
a main cylindrical body having a projection on an outer surface thereof and having a first end and a second end, the first end being coupled with a bottom of the main nut;
a main nut gasket engaged with the main cylindrical body;
a spring body coupled with the second end of the main cylindrical body;
a first slip ring engaged with the spring body;
an insulator coupled with the main cylindrical body;
a resistor electrically coupled with an outer surface of the main nut; and
a center pin coupled with the insulator and the resistor.

10. The terminator assembly of claim 9, further comprising an outer sleeve electrically coupling the resistor with the outer surface of the main nut.

11. The terminator assembly of claim 9, wherein the main nut has wrench flats or a knurled outer surface on sides thereof.

12. The terminator assembly of claim 9, wherein the projection is a thread, a twist lock male, or a bayonet male.

13. The terminator assembly of claim 9, wherein the spring body comprises a spring tine or a braid compression barrel.

14. The terminator assembly of claim 9, wherein the resistor is 75 ohm.

15. A connector adaptor assembly for a housing receptacle assembly comprising a housing body having a gasket seat and a bore, a ferrule in the bore, the ferrule having a first opening at a bottom of the gasket seat, a tapered cable center conductor alignment section having a second opening and a third opening smaller than the second opening, the second opening being coupled with the first opening, and a housing female center pin coupled with the third opening, the connector adaptor assembly comprising:
a main nut;
a main cylindrical body having a projection on an outer surface thereof and having a first end and a second end, the first end being coupled with a bottom of the main nut;
a main nut gasket engaged with the main cylindrical body;
a spring body coupled with the second end of the main cylindrical body;
a first slip ring engaged with the spring body;
an insulator coupled with the second end of the main cylindrical body;
a feed through center pin coupled with the insulator; and
a test port coupled with the main nut.

16. The connector adaptor assembly of claim 15, further comprising an outer sleeve electrically coupled with a port inserted in the main nut.

17. The connector adaptor assembly of claim 15, wherein the main nut has wrench flats or a knurled outer surface on sides thereof.

18. The connector adaptor assembly of claim 15, wherein the projection is a thread, a twist lock male, or a bayonet male.

19. The connector adaptor assembly of claim 15, wherein the spring body comprises a spring tine or a braid compression barrel.

20. The terminator assembly of claim 15, wherein the test port is a 75 ohm F female port, a 75 ohm BNC female port, a 75 ohm N female port, or a 75 ohm MCX female port.
